(19) United States
(12) Patent Application Publication
(10) Pub. No.: US 2022/0247048 A1
(43) Pub. Date: Aug. 4, 2022

(54) BATTERY

(71) Applicant: HONDA MOTOR CO., LTD., Tokyo (JP)

(72) Inventors: Masahiro Ohta, Saitama (JP); Takuya Taniuchi, Saitama (JP)

(21) Appl. No.: 17/584,400

(22) Filed: Jan. 26, 2022

(30) Foreign Application Priority Data
Feb. 1, 2021 (JP) 2021-014613

(51) Int. Cl. H01M 50/583; H01M 50/54

(52) U.S. Cl. CPC H01M 50/583; H01M 2200/106; H01M 50/54

(57) ABSTRACT

A battery includes one or more stacks, an outer packaging body, a lead terminal, and a plurality of overcurrent breaking portions. The one or more stacks each include a positive electrode including a positive electrode current collector, an electrolyte, and a negative electrode including a negative electrode current collector arranged in a repeating pattern. At least the positive electrode current collector or the negative electrode current collector includes a current collector tab that extends from an end face thereof. The tab constitutes a plurality of current collector tab groups. The lead terminal at least partially extends from the outer packaging body to an outside. The plurality of overcurrent breaking portions are disposed inside the outer packaging body and electrically connected to the lead terminal. The plurality of current collector tab groups are respectively electrically connected to the plurality of overcurrent breaking portions.

This application is based on and claims the benefit of priority from Japanese Patent Application No. 2021-014613, filed on 1 Feb. 2021, the content of which is incorporated herein by reference.

### BACKGROUND OF THE INVENTION

### Field of the Invention

The present invention relates to a battery.

### Related Art

Recently, the demand for batteries with high capacity and high output has rapidly expanded due to the spread of various electric and electronic devices of various sizes such as automobiles, personal computers, and mobile phones. As such a battery, a liquid battery cell in which an organic electrolytic solution is used as an electrolyte between a positive electrode and a negative electrode is widely used.

The battery is used in connection with a fuse to prevent damage to components or accidents when overcurrent flows during abnormal conditions. For example, a secondary battery mounted for driving an electric vehicle is used in connection with a fuse that breaks current by blowing due to an overcurrent (for example, see Patent Document 1).
Patent Document 1: Japanese Unexamined Patent Application, Publication No. 2014-150664

### SUMMARY OF THE INVENTION

Conventional overcurrent breaking devices and mechanisms break excessive current flowing between battery cells and external devices. However, it is also required to break an internal short-circuit current flowing in a battery cell, which is caused by a fault (mainly internal short circuit) occurring in the battery cell. This is because the internal short-circuit current generates Joule heat, which causes the temperature of the battery cell to rise, resulting in unsafe events such as toxic gases and combustion of the battery cell.

In recent years, in addition to a liquid battery including an electrolytic solution as an electrolyte, techniques relating to a solid-state battery including a flame-retardant solid electrolyte as an electrolyte have been proposed. However, even with solid-state batteries, if an internal short circuit occurs and the temperature reaches the point where a decomposition reaction occurs, an enormous amount of heat may be generated, destroying an outer packaging body and other parts, causing unsafe events such as generation of toxic gases and combustion reactions.

In response to the above issue, it is an object of the present invention to provide a battery with high safety capable of reducing a temperature rise in an internal short-circuit area by reducing an internal short-circuit current.

(1) A first aspect of the present invention relates to a battery including one or more stacks, an outer packaging body, a lead terminal, and a plurality of overcurrent breaking portions. The one or more stacks each include a positive electrode including a positive electrode current collector, an electrolyte, and a negative electrode including a negative electrode current collector arranged in a repeating pattern. At least the positive electrode current collector or the negative electrode current collector includes a current collector tab that extends from an end face thereof. The tab constitutes a plurality of current collector tab groups. The outer packaging body houses the one or more stacks. The lead terminal at least partially extends from the outer packaging body to an outside. The plurality of overcurrent breaking portions are disposed inside the outer packaging body and electrically connected to the lead terminal. The plurality of current collector tab groups are respectively electrically connected to the plurality of overcurrent breaking portions.

According to the invention of the first aspect, by reducing an internal short-circuit current, a temperature rise in an internal short-circuit area can be reduced, and thus a battery with high safety can be provided.

(2) In a second aspect of the present invention according to the first aspect, the overcurrent breaking portions are positive temperature coefficient (PTC) thermistors.

According to the invention of the second aspect, the battery can continue to be used even after an overcurrent has occurred, without the need for replacement of parts.

(3) In a third aspect of the present invention according to the first or second aspect, the outer packaging body includes a welded part, and the overcurrent breaking portions are disposed in the welded part.

According to the invention of the third aspect, even in a liquid battery, the battery can be provided with an overcurrent breaking function, and the volumetric energy density of the battery can be improved.

(4) A fourth aspect of the present invention relates to a battery member used in the battery according to any one of the first to the third aspects. The lead terminal and the plurality of overcurrent breaking portions electrically connected to the lead terminal are integrated.

According to the invention of the fourth aspect, the battery according to any one of the first to the third aspects can be preferably configured.

### BRIEF DESCRIPTION OF THE DRAWINGS

FIG. 1 shows an overview of a solid-state battery according to a first embodiment of the present invention;

FIG. 2 shows an overview of a solid-state battery according to a second embodiment of the present invention;

FIG. 3 is a side sectional view of a solid-state battery according to an embodiment of the present invention;

FIG. 4 is a side sectional view of an overcurrent breaking portion according to an embodiment of the present invention;

FIG. 5 is a perspective view of an overcurrent breaking portion according to an embodiment of the present invention;

FIG. 6 is a sectional view taken along line A-A in FIG. 5;

FIG. 7 is a sectional view taken along line B-B in FIG. 5;

FIG. 8 is an exploded perspective view of an overcurrent breaking portion according to an embodiment of the present invention; and

FIG. 9 is a graph showing the relationship between the presence or absence of an overcurrent breaking portion and an initial short-circuit current.

### DETAILED DESCRIPTION OF THE INVENTION

Embodiments of the present invention will now be described with reference to the drawings. However, the following embodiments exemplify the present invention, and the present invention is not limited to the following embodiments.

### First Embodiment

### <Battery>

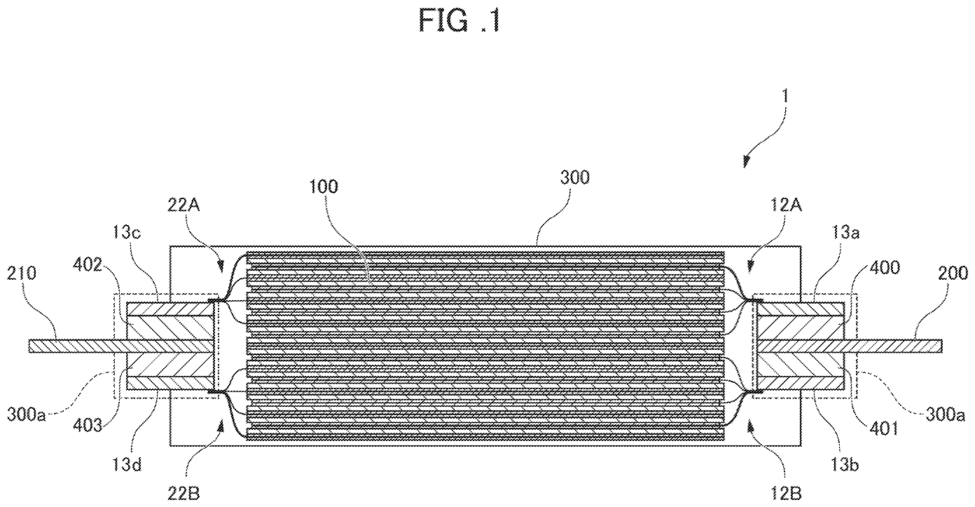

A battery 1 according to this embodiment is a solid-state battery. As shown in FIG. 1, the battery 1 includes a stack 100, lead terminals 200 and 210, and an outer packaging body 300. A plurality of positive electrode current collector tab groups 12A and 12B extend from an end face of the stack 100. The positive electrode current collector tab groups 12A and 12B are respectively electrically connected to the lead terminal 200 via connecting plates 13a and 13b and overcurrent breaking portions 400 and 401. Similarly, a plurality of negative electrode current collector tab groups 22A and 22B extend from the other end face of the stack 100. The negative electrode current collector tab groups 22A and 22B are respectively electrically connected to the lead terminal 210 via connecting plates 13c and 13d and overcurrent breaking portions 402 and 403. The battery 1 is described below as a solid-state battery, but it may also be a liquid battery with a liquid electrolyte.

### (Stack)

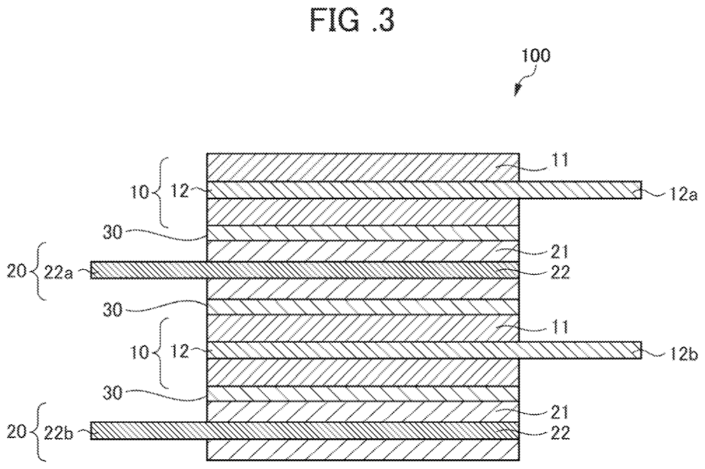

As shown in FIG. 3, the stack 100 has a structure in which a positive electrode 10 and a negative electrode 20 are alternately, repeatedly stacked via a solid electrolyte 30 disposed therebetween. The stack 100 according to this embodiment is an example in which a stack unit of the positive electrode 10, the solid electrolyte 30, and the negative electrode 20 is repeatedly stacked for a total of two times. The stack 100 according to this embodiment is housed in a laminate cell 300 as an outer packaging body. However, if there are a plurality of stacks 100, the stack 100 may be a wound body that is housed in a cylindrical outer packaging body.

In the positive electrode 10, positive electrode active material layers 11 are respectively stacked on both sides of a positive electrode current collector 12. In the negative electrode 20, negative electrode active material layers 21 are respectively stacked on both sides of a negative electrode current collector 22. The current collector and the electrode active material layers may be separate, or may be integrated.

### [Positive Electrode Active Material Layer]

The positive electrode active material that constitutes the positive electrode active material layer 11 is not limited, and any substance known as a positive electrode active material for solid-state batteries can be applied. There are no restrictions on its composition, and it may contain a solid electrolyte, a conductivity aid, a binder, and the like. Examples of the positive electrode active material include transition metal chalcogenides such as titanium disulfide, molybdenum disulfide, and niobium selenide; and transition metal oxides such as lithium nickelate (LiNiO₂), lithium manganate (LiMnO₂, LiMn₂O₄), and lithium cobaltate (LiCoO₂).

### [Positive Electrode Current Collector]

The positive electrode current collector 12 is not limited, and any known current collector that can be used for a positive electrode of a solid-state battery can be applied. For example, metal foils such as stainless steel (SUS) foil and aluminum (Al) foil can be used.

### [Negative Electrode Active Material Layer]

The negative electrode active material that constitutes the negative electrode active material layer 21 is not limited, and any substance known as a negative electrode active material for solid-state batteries can be applied. There are no restrictions on its composition, and it may contain a solid electrolyte, a conductivity aid, a binder, and the like. Examples of the negative electrode active material include lithium alloys such as lithium metal, Li—Al alloys, and Li—In alloys; lithium titanate such as Li₄Ti₅O₁₂; and carbon materials such as carbon fiber and graphite.

### [Negative Electrode Current Collector]

The negative electrode current collector 22 is not limited, and any known current collector that can be used for a negative electrode of a solid-state battery can be applied. For example, metal foils such as stainless steel (SUS) foil and copper (Cu) foil can be used.

### [Current Collector Tab]

A plurality of positive electrode current collector tabs 12a and 12b extend in the same direction and substantially in parallel from one end face of the stack 100. A plurality of positive electrode current collector tabs 12c and 12d similarly extend in the same direction and substantially in parallel from one end face of a stack 101. In this embodiment, the above positive electrode current collector tabs respectively extend from the corresponding positive electrode current collectors 12.

Similarly, a plurality of negative electrode current collector tabs 22a and 22b respectively extend in the same direction, substantially in parallel, and in a planar shape from the other end faces of the stacks 100 and 101. The above negative electrode current collector tabs may extend from one end face of the stack 100 in the same manner as the positive electrode current collector tabs. The negative electrode current collector tabs respectively extend from the corresponding negative electrode current collectors 22.

In the present invention, the current collector tabs only need to respectively extend from the current collectors, which is not limited to drawing. For example, the current collector tabs may be made of different materials from the positive electrode current collectors 12 and the negative electrode current collectors 22.

The width of the current collector tab is set as appropriate to reduce the resistance of the current collector tab depending on the purpose of use, using the width of the electrode material mixture as the maximum, and preferably 1 mm to 1000 mm, more preferably 2 mm to 300 mm. The thickness is generally about 5 μm to 50 μm, and the length is generally about 5 mm to 50 mm.

### [Current Collector Tab Group]

A plurality of positive electrode current collector tabs are divided into a plurality of groups and bundled to form a plurality of current collector tab groups. The same applies to a plurality of negative electrode current collector tabs. As shown in FIG. 1, the plurality of positive electrode current collector tab groups 12A and 12B are respectively electrically connected to the connecting plates 13a and 13b. Similarly, the plurality of negative electrode current collector tab groups 22A and 22B are respectively electrically connected to the connecting plates 13c and 13d. This structure allows the battery 1 to function as if a plurality of stacks are connected in parallel.

The joining method by which the plurality of positive electrode current collector tab groups 12A and 12B are respectively joined to the connecting plates 13a and 13b is not limited, and known methods such as welding, such as resistance welding or ultrasonic welding, and deposition can be used. In this embodiment, the structure in which the plurality of positive electrode current collector tab groups described above are respectively electrically connected to the lead terminal 200 via the connecting plates 13a and 13b and the overcurrent breaking portions 400 and 401 will be described. The same structure can be applied to the negative electrode current collector tab groups 22A and 22B. It is preferable that at least the plurality of positive electrode current collector tab groups or the plurality of negative electrode current collector tab groups are respectively electrically connected to the lead terminal 200 or 210 via the corresponding overcurrent breaking portions.

### [Solid Electrolyte]

The solid electrolyte 30 is stacked between the positive electrode 10 and the negative electrode 20, and is formed, for example, in the form of a layer. The solid electrolyte 30 is a layer that contains at least a solid electrolyte material. Charge transfer between the positive electrode active material and the negative electrode active material can be performed through the solid electrolyte material.

The solid electrolyte material is not limited, and examples thereof include a sulfide solid electrolyte material, an oxide solid electrolyte material, a nitride solid electrolyte material, and a halide solid electrolyte material.

### (Lead Terminal)

As shown in FIG. 1, one end side of the lead terminal 200 is electrically connected to the plurality of positive current collector tab groups by welding or other means via the overcurrent breaking portions 400 and 401. The other end side extends from the outer packaging body 300 to constitute an electrode portion of the solid-state battery 1. Similarly, the lead terminal 210 is electrically connected to the plurality of negative electrode current collector tab groups.

The lead terminals 200 and 210 are not limited, and preferably flexible wire-like plate members such as aluminum (Al) or copper (Cu). In general, the thickness of the lead terminals 200 and 210 is about 0.05 mm to 5 mm, which is thicker than the thickness of the current collector tabs.

The lead terminal 200 is electrically connected to the overcurrent breaking portions 400 and 401 inside the outer packaging body 300. That is, the overcurrent breaking portions 400 and 401 are disposed inside the outer packaging body 300. The lead terminal 210 is similarly electrically connected to the overcurrent breaking portions 402 and 403.

### (Outer Packaging Body)

The outer packaging body 300 houses the stacks 100 and 101, the plurality of positive electrode current collector tabs 12a to 12d, and the overcurrent breaking portions 400 and 401. The outer packaging body 300 is not limited, and for example, a laminate cell including a laminate film is used. The laminate cell has a multi-layered structure with a thermal fusion resin layer such as polyolefin laminated on the surface of a metal layer made of aluminum, stainless steel (SUS), or the like, for example. In addition to the above, the laminate cell may include a layer made of polyamide such as nylon, polyester such as polyethylene terephthalate, or the like, an adhesive layer including any laminate adhesive, or the like.

With respect to the laminate cell, for example, a single rectangular laminate film is folded to sandwich the stack 100 and others, and then sealed around the outside of the stack 100 and others by a heat-sealing method or other method to house the stack 100 and others in the interior. The outer packaging body 300 is not limited to the laminate cell, and may be, for example, a metal outer packaging body that is formed in a cylindrical shape.

### [Overcurrent Breaking Portion]

The overcurrent breaking portions 400 to 403 are positive temperature coefficient (PTC) thermistors in this embodiment. The resistance value of the PTC thermistor rapidly increases when the temperature exceeds a certain temperature (Curie temperature). Under normal conditions, the PTC thermistor can be energized, but when an overcurrent flows through the PTC thermistor, the resistance value increases due to self-heating by Joule heat. Thus, the current flowing through the PTC thermistor decays. This breaks the overcurrent flowing through the PTC thermistor. By using a PTC thermistor as an overcurrent breaking portion, the battery 1 can continue to be used without the need for replacement of parts after the occurrence of an overcurrent. The PTC thermistor is not limited, and for example, semiconductor ceramics with barium titanate as the main component can be used. The Curie temperature can be optionally set by adjusting the material composition. The overcurrent breaking portion may be a blown type fuse that blows due to an overcurrent.

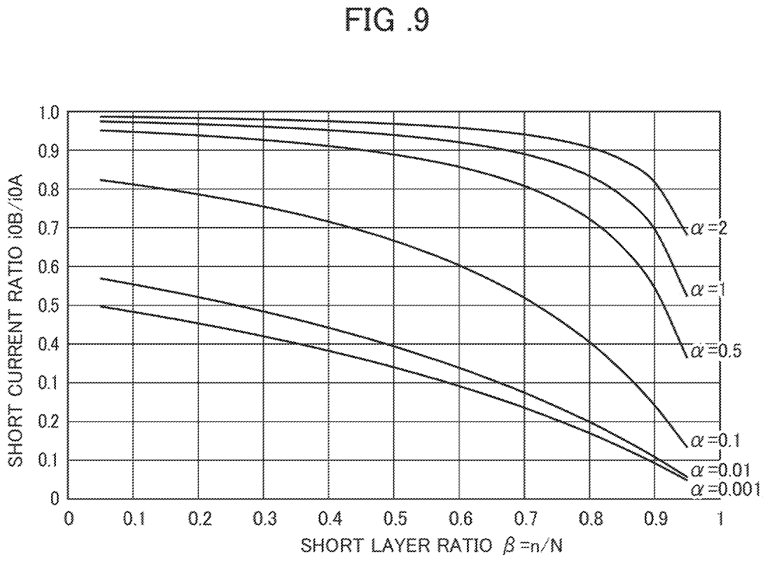

FIG. 9 is a graph showing the effect of a battery with the overcurrent breaking portions according to the present embodiment. The vertical axis in FIG. 9 shows the ratio of i_{OB}/i_{OA}, which is the ratio of the initial short-circuit current i_{OB} of a battery with the overcurrent breaking portions according to the present embodiment to the initial short-circuit current i_{OA} of a battery without an overcurrent breaking portion. The horizontal axis in FIG. 9 shows n/N, which is the ratio of the number n of short-circuit units (stacks) to the number N of battery units (stacks). α represents R_{S0}/r₀, which is the ratio of the initial short-circuit resistance R_{S0} to the internal resistance r₀, per pair of battery units (stacks). The smaller the short-circuit resistance, the larger the short-circuit current, and the more likely it is that a serious unsafe event will occur. As shown in FIG. 9, it is clear that the smaller α is, the greater the effect of the short-circuit current reduction of the battery according to the present embodiment, which indicates that the occurrence of unsafe events can be suppressed by this embodiment.

α is preferably 1 or less.

The overcurrent breaking portions 400 to 403 are disposed inside the outer packaging body 300. This eliminates the need to dispose fuses, for example, on bus bars outside the solid-state battery 1. Therefore, the installation space of the solid-state battery 1 can be reduced, and thus the energy density of the solid-state battery 1 can be improved. In this embodiment, the overcurrent breaking portions are disposed in a welded part 300a in which outer packaging bodies 300 are welded together. This prevents sparks from reaching the stacks 100 and 101, even when blown-type fuses are used as the overcurrent breaking portions and the fuses blow. Therefore, the battery 1 can be configured as a liquid battery including a liquid electrolyte.

### <Battery Member>

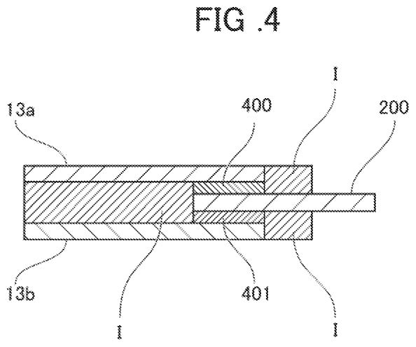

A battery member according to the present embodiment is used in the battery 1 and has a structure in which a lead terminal and a plurality of overcurrent breaking portions are integrated. FIG. 4 shows an example of the configuration of the battery member according to this embodiment. FIG. 4 is a sectional schematic view showing the configuration of the overcurrent breaking portions 400 and 401. As shown in FIG. 4, the overcurrent breaking portion 400 is provided between the connecting plate 13a and the lead terminal 200, and is electrically connected to the connecting plate 13a and the lead terminal 200. Similarly, the overcurrent breaking portion 401 is provided between the connecting plate 13b and the lead terminal 200, and is electrically connected to the connecting plate 13b and the lead terminal 200. The connecting plate 13a is electrically connected to the positive electrode current collector tab group 12A in FIG. 1. Similarly, the connecting plate 13b is electrically connected to the positive electrode current collector tab group 12B. The lead terminal 200 and the connecting plates 13a and 13b are electrically insulated by insulating members I. The connecting plate 13a and 13b are electrically insulated by the insulating members I.

The overcurrent breaking portions 400 and 401 are respectively provided for the corresponding positive electrode current collector tab groups, and are respectively electrically connected to the corresponding positive electrode current collector tab groups via the connecting plates 13a and 13b. The overcurrent breaking portions 400 and 401 are both electrically connected to the single lead terminal 200. As a result, when an internal short-circuit current occurs in one stack connected to one positive electrode current collector tab group, the internal short-circuit current flowing from the point where the internal short circuit has occurred to the other stack connected to the other positive electrode current collector tab group can be suppressed. Therefore, the temperature rise of the battery 1 can be suppressed, and unsafe events can be suppressed. In addition to the above, the overcurrent flowing from the connecting plate connected to the stack in which the internal short circuit has occurred to the lead terminal 200 is broken, whereas the current flowing from the connecting plate connected to the stack in which the internal short circuit has not occurred to the lead terminal 200 is maintained. Therefore, when an internal short circuit occurs, a device to which the battery 1 is connected is not stopped, and the overcurrent can be prevented from flowing to the outside through the lead terminal 200. At the same time, the overcurrent flowing from the outside to the stack 100 is broken by the overcurrent breaking portions 400 and 401.

Other embodiments of the present invention will be described below. The description of the same structure as that of the first embodiment may be omitted.

### SECOND EMBODIMENT

### <Battery>

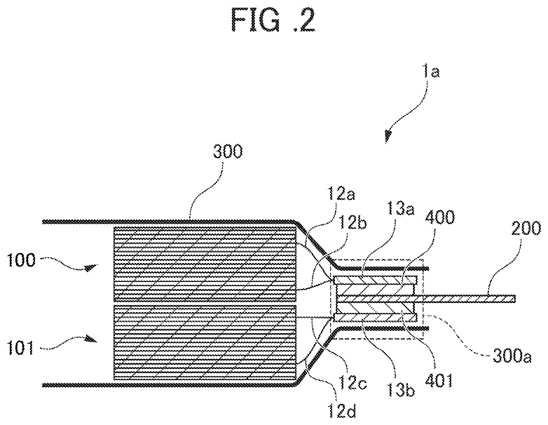

As shown in FIG. 2, a battery 1a according to this embodiment includes a plurality of stacks 100 and 101, a lead terminal 200, and an outer packaging body 300. The plurality of stacks 100 and 101 are electrically independent inside the battery 1a. A plurality of positive electrode current collector tabs 12a and 12b extending from an end face of the stack 100 are electrically connected to the lead terminal 200 via a connecting plate 13a and an overcurrent breaking portion 400. Similarly, a plurality of positive electrode current collector tabs 12c and 12d extending from an end face of the stack 101 are electrically connected to the lead terminal 200 via a connecting plate 13b and an overcurrent breaking portion 401.

The stack 101 has the same structure as the stack 100. The stacks 100 and 101 are electrically independent, and an insulator such as an insulating sheet is disposed between the stacks (not shown). The overcurrent breaking portions 400 and 401 are both electrically connected to the single lead terminal 200. As a result, when an overcurrent occurs due to an internal short circuit in any of the stack 100 and 101 constituting the battery 1a, the internal short-circuit current flowing from one stack in which the internal short circuit has occurred to the other stack can be more reliably suppressed. In addition, the overcurrent flowing from the connecting plate connected to the stack in which the internal short circuit has occurred to the lead terminal 200 is broken, but the current flowing from the connecting plate connected to the stack in which the internal short circuit has not occurred to the lead terminal 200 is maintained.

### THIRD EMBODIMENT

### <Battery Member>

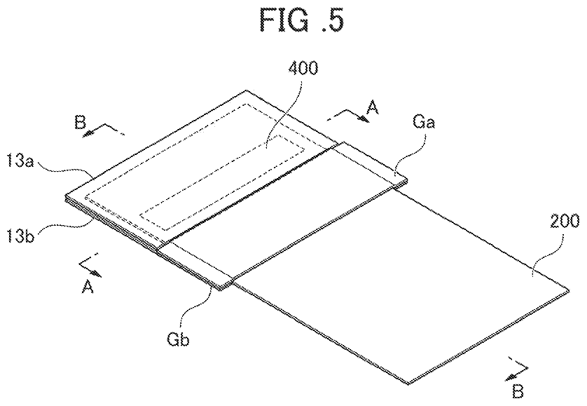

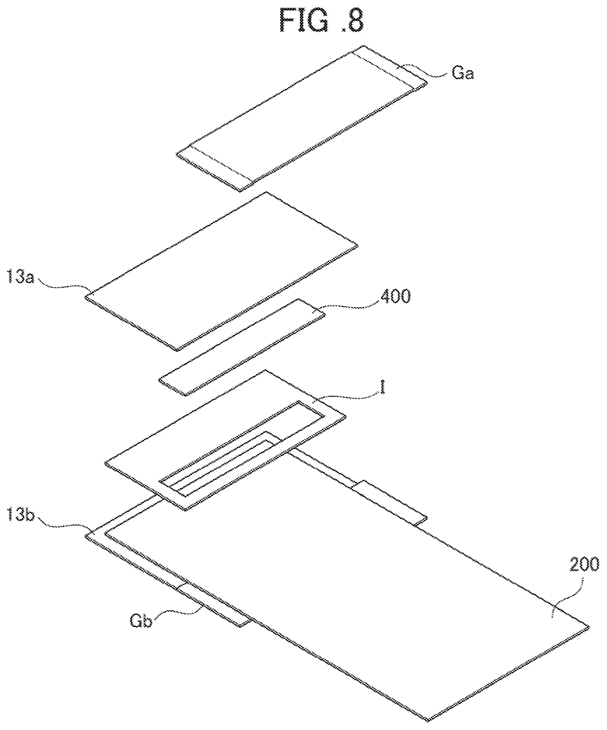

FIG. 5 shows the configuration of a battery member including an overcurrent breaking portion 400 according to this embodiment. As shown in FIGS. 5 to 8, similarly to the first embodiment, two overcurrent breaking portions 400 and 401 are provided. The overcurrent breaking portions 400 and 401 are positive temperature coefficient (PTC) thermistors, and each have a periphery in a thickness direction that is covered with an insulator I. Insulators I are plate members that are respectively provided for the overcurrent breaking portions 400 and 401, and respectively have voids that can house the overcurrent breaking portions. The overcurrent breaking portion 400 is disposed so that the upper face thereof contacts a connecting plate 13a, and the lower face thereof contacts a lead terminal 200. Similarly, the overcurrent breaking portion 401 is disposed so that the upper face thereof contacts the lead terminal 200, and the lower face thereof contacts a connecting plate 13b. These members thus configured are sandwiched and fixed from above and below between gaskets Ga and Gb. This allows the members to be electrically connected at the points of contact. The connecting plates 13a and 13b are respectively electrically connected to the lead terminal 200 via the overcurrent breaking portions 400 and 401 without directly contacting the lead terminal 200.

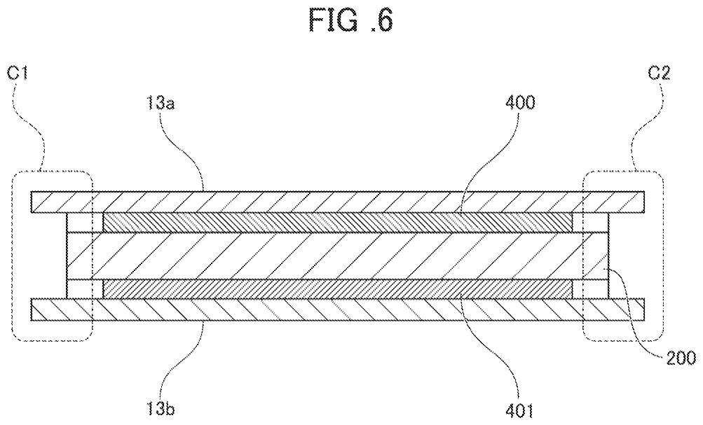

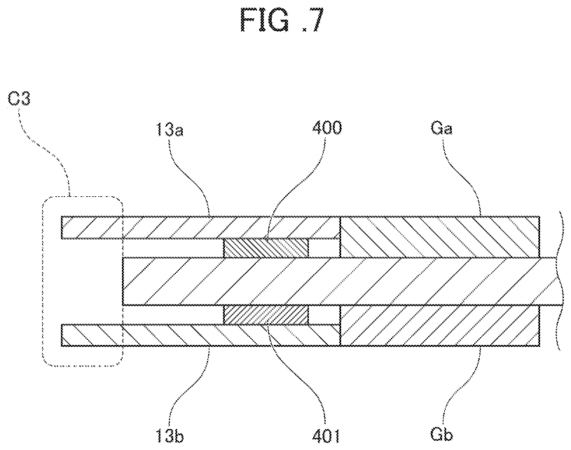

The connecting plate 13a has an area in plan view larger than the total area of the overcurrent breaking portion 400 and the insulator I, and is disposed to completely cover the overcurrent breaking portion 400 and the insulator I. Similarly, the connecting plate 13b has an area in plan view larger than the total area of the overcurrent breaking portion 401 and the insulator I, and is disposed to completely cover the overcurrent breaking portion 401 and the insulator I. In FIGS. 6 and 7, end portions of the connecting plates 13a and 13b, i.e., C1 to C3 are preferably crimped to reduce the contact resistance between the overcurrent breaking portion 400 and the connecting plate 13a and the contact resistance between the overcurrent breaking portion 401 and the connecting plate 13b. The connecting plates 13a and 13b are preferably crimped so that the connecting plate 13a is electrically connected only to the overcurrent breaking portion 400 and the connecting plate 13b is electrically connected only to the overcurrent breaking portion 401.

Although preferred embodiments of the present invention have been described above, the present invention is not limited to the above embodiments. The scope of the present invention includes those appropriately modified to the extent that the effect of the present invention is not impaired.

### EXPLANATION OF REFERENCE NUMERALS

1, 1a battery
10 positive electrode
12 positive electrode current collector
12A, 12B positive electrode current collector tab group (current collector tab group)
12a, 12b, 12c, 12d positive electrode current collector tab
20 negative electrode
22 negative electrode current collector
22A, 22B negative electrode current collector tab group (current collector tab group)
30 solid electrolyte
100, 101 stack
200, 210 lead terminal
300 outer packaging body
300a welded part
400, 401, 402, 403 overcurrent breaking portion

What is claimed is:

1. A battery, comprising:
one or more stacks;
an outer packaging body;
a lead terminal; and
a plurality of overcurrent breaking portions,
the one or more stacks each comprising a positive electrode comprising a positive electrode current collector, an electrolyte, and a negative electrode comprising a negative electrode current collector arranged in a repeating pattern,
at least the positive electrode current collector or the negative electrode current collector comprising
a current collector tab that extends from an end face thereof, the tab constituting a plurality of current collector tab groups,
the outer packaging body housing the one or more stacks,
the lead terminal at least partially extending from the outer packaging body to an outside,
the plurality of overcurrent breaking portions being disposed inside the outer packaging body and electrically connected to the lead terminal, and
the plurality of current collector tab groups being respectively electrically connected to the plurality of overcurrent breaking portions.

2. The battery according to claim 1, wherein the overcurrent breaking portions are positive temperature coefficient (PTC) thermistors.

3. The battery according to claim 1, wherein the outer packaging body comprises a welded part, and the overcurrent breaking portions are disposed in the welded part.

4. A battery member used in the battery according to claim 1, wherein
the lead terminal and the plurality of overcurrent breaking portions electrically connected to the lead terminal are integrated.
